(19) United States
(12) Patent Application Publication
(10) Pub. No.: US 2002/0106435 A1
(43) Pub. Date: Aug. 8, 2002

(54) System and method for making ready-to-serve soup

(76) Inventors: Jim Fish, Carmel, IN (US); Paul W. Gics, Sewickley, PA (US); Joe McSharry, Carmel, IN (US)

Correspondence Address: Patrick A. Doody, Esq., Hunton & Williams, Suite 1200, 1900 K Street, N.W., Washington, DC, 20006, US

(21) Appl. No.: 09/840,822

(22) Filed: Apr. 25, 2001

Related U.S. Application Data
(60) Provisional application No. 60/266,482, filed on Feb. 6, 2001.

(51) Int. Cl. A23L 1/238

(52) U.S. Cl. 426/589

(57) ABSTRACT

A system and method for making a ready-to-serve soup includes cooking the soup in a condensed form at a maximum temperature of about 180° F. and for an effective time to achieve sufficient cooking of the condensed soup. The method further includes heating the condensed, cooked soup to an effective temperature and for an effective period of time achieve sufficient microbial kill. A broth diluent is added to the condensed, cooked soup to form a ready-to-serve soup product having a desired consistency.

### FIELD OF THE INVENTION

The present invention relates generally to a system and method for making ready-to-serve soup, and to a stand-up, reclosable, and microwaveable plastic bag for storing and cooking the ready-to-serve soup.

### BACKGROUND OF THE INVENTION

Ready-to-serve soups pose unique challenges. For example, it is difficult to take a large batch of soup having a wide variety of ingredients of varying weights and densities, and then dispense the soup into small portions that have an even distribution of ingredients. Generally, the consistency of the final soup product may vary significantly from batch to batch and even from container to container. Another challenge is to apply sufficient heat to the soup in order to reduce spoilage, i.e., to increase shelf-life, yet not to overcook the soup, including the vegetables, meats, and noodles.

Prior processes employ relatively high cooking temperatures in order to achieve sufficient microbial kill. Such cooking processes require very precise time and temperature controls to avoid overcooking. Even a minor amount of overcooking at the very high cooking temperatures employed in the prior art can result in large variations in the taste and quality of the various soup ingredients. For example, overcooking generally changes the specific gravity of soup ingredients, such as pasta and vegetables, and causes them to become mushy and saturated with water. Thus, it is highly desirable to avoid over-cooking ready-to-serve soups in order to preserve a certain degree of crunchiness in the particulate matter added to this soup, most importantly, the vegetables added to the soup, and to maintain the proper consistency of the meat and pasta which also may be added to the soup.

Stand-up, re-cloasable, plastic bags are well-known in the industry. For example, a variety of plastic bags are disclosed in U.S. Pat. Nos. 2,265,075, 3,715,074, and 4,353,497. In addition, plastic bags including a zipper-type closure device along the top opening or mouth of the bags, are generally known, and described in, for example, U.S. Pat. Nos. 4,601,694, 4,055,109, and 3,980,225, and in U.K. Patent Application No. 2,047,199. The disclosures of these documents are incorporated by reference herein in their entirety.

Consumers greatly desire a stand-up, re-closable plastic bag because it is convenient to fill, and is capable of storing highly liquid foods. Consumers also desire a bag capable of microwave heating of foods directly in the bag. Some known stand-up bags attempt to provide the stand-up capability merely by use of a simple bottom alone or supplemented with seals added in the bottom structure. A simple bottom sealed at its sides does not provide a normal consumer plastic bag with a sufficient stand-up feature. Such plastic bag typically made from polyethylene film, for example of under 1.0 mil thickness, is too limp to stand up from the bottomed bottom. In addition, the bottom of these bags typically contacts the surface on which it is standing, even when empty. Additional improvements are required before consumers will be comfortable purchasing a stand-up, re-closable, microwaveable plastic bag that fully meets their needs.

These and other deficiencies in prior ready-to-serve soup products are overcome in accordance with the system disclosed herein, the method of manufacturing the soup using the disclosed system, and the stand-up, re-closable, microwavable plastic bag disclosed herein.

### SUMMARY OF THE INVENTION

It is a feature of the present invention to provide a refrigerated soup that is stored and sold for retail sale inside a stand-up, re-closable plastic bag. It is another feature of the present invention to provide a refrigerated soup that can be transformed into a hot, drinkable soup inside the stand-up, re-closable plastic bag. It is yet another feature of the present invention to provide a refrigerated soup product that has sufficient shelf life and a fresher taste and aroma than prior art refrigerated soups.

According to one aspect of the present invention, an advantageous process for making the refrigerated soup comprises adding the soup ingredients inside a cook-up vessel to prepare a soup in a condensed form. A soup in a condensed form, also referred to hereinafter as “condensed soup,” is a soup having all the ingredients, but only a small portion of the soup broth of the final soup product. The condensed soup is cooked to a maximum temperature of about 180° F. and for an effective time to achieve sufficient cooking of the soup ingredients.

The present invention further comprises heating the condensed soup to an effective temperature and for an effective period of time to achieve sufficient microbial kill. The present invention further comprises adding a broth diluent to the condensed, cooked soup to form a soup product having the desired consistency.

The present invention advantageously preserves the freshness, taste, and aroma of the soup ingredients, while achieving sufficient microbial kill to ensure sufficient shelf life for the refrigerated soup. The soup made according to the present system and process provides for more consistency in the amount of particulates provided in each bag. Likewise, the particulates in each bag do not become over-saturated and thus retain a freshness and crunchiness similar to homemade soup.

It is an additional feature of the invention to a stand-up, re-closable, and microwave-able plastic bag that includes front and rear sidewalls and a gusset bottom wall. The front and rear sidewalls each preferably have upper edges and define an open mouth at the upper edges thereof. The gusset bottom wall is disposed between the front and rear sidewalls. It is preferred that the front and rear sidewalls, and the gusset bottom wall be comprised of an interior layer and an exterior layer, the interior layer being heat-sealable within a pre-defined temperature range, and the exterior layer not being heat-sealable within that pre-defined temperature range.

It also is preferred that the gusset bottom wall be comprised of inwardly folded members whereby the lower inside portions of the inwardly folded members are joined to lower inside portions of the front and rear sidewalls at contiguous interior surface portions thereof to form a support band. It is further preferred that the front and rear sidewalls and the inwardly folded members of the gusset bottom wall are joined by heat seals at contiguous portions thereof.

These and other advantages of the method and system for making ready-to-serve soup will become more readily apparent to those skilled in the art by reading the following detailed description of the preferred embodiments in conjunction with the attached drawings. These and other advantages of the stand-up, re-closable, microwavable plastic bag also will become readily apparent to those skilled in the art by reading the following description in conjunction with the drawings.

### BRIEF DESCRIPTION OF THE DRAWINGS

FIGS. 1A and 1B illustrate the preferred processing steps used to make the refrigerated, bagged soup according to an embodiment of the present invention.

FIGS. 2 and 3 are schematic system diagrams of a preferred system for making the refrigerated, bagged soup according to an embodiment of the present invention.

FIG. 4 is a simplified schematic of a freezer apparatus employed in a preferred embodiment of the present invention.

FIG. 5 is a simplified system diagram of a filler apparatus and associated equipment according to a preferred embodiment of the present invention.

FIG. 6 is a simplified schematic of a preferred bag employed in an embodiment of the present invention.

FIG. 6A is cross-sectional partial view of the plastic bag of FIG. 6 along line 6A-6A.

### DETAILED DESCRIPTION OF THE PREFERRED EMBODIMENTS

According to a first preferred embodiment of the present invention, a method for making a refrigerated soup comprises adding a portion of the soup ingredients inside a cook-up kettle. It has been unexpectedly discovered that by adding most of the broth diluent at later stages of the cooking process, the problems associated with overcooking are eliminated or substantially reduced. Preferably, the condensed soup in the cook-up kettle has from about 20 to about 85 percent, and more preferably from about 40 to about 65 percent, of the final soup weight. The remainder of the soup is obtained by adding most of the broth diluent at later stages of the process. Because only a small amount of diluent broth is added to the soup in the cooking stage, the cook-up vessel preferably is equipped with an agitator to sufficiently suspend the particulates in the condensed soup. The degree of agitation may vary depending upon the exact composition of the soup. For example, some soup products, such as bean and pasta products, require vigorous agitation to prevent undesirable clumping of the soup ingredients. On the other hand, other soup products may be damaged by excessive agitation. For example, cream soups tend to separate and delicate ingredients tend to break apart.

The condensed soup preferably is cooked in the cook-up kettle to a maximum temperature of about 180° F. and for an effective period of time to achieve sufficient cooking of the soup ingredients without overcooking. The exact temperature and time of the cooking stage may vary depending upon the composition of the soup. Generally, cooking the condensed soup at a temperature higher than about 180° F. for any significant length of time results in a loss of taste and freshness of the soup ingredients. Preferably, the cooking procedure includes heating the soup in a condensed form to a temperature of from about 100° F. to about 180° F., more preferably from about 130° F. to about 160° F., and most preferably from about 140° F. to about 150° F. An effective cooking time may range anywhere from about 1 to about 60 minutes, preferably from about 5 to about 40 minutes and more preferably from about 10 to about 25 minutes.

The method according to a preferred embodiment further comprises heating the cooked soup to a certain temperature for an effective period of time to achieve sufficient microbial kill that will allow an adequate shelf life without overheating the soup ingredients. Preferably, the cooked soup is heated so that the ultimate refrigerated soup has a shelf-life of at least 40 days, and more preferably of at least 80 days. Preferably, the temperature and time of the microbial kill should accomplish at least a 12-log reduction in Listeria Monocytogenes bacteria. On the other hand, the time of this process should be minimized to avoid overcooking of the soup ingredients. Preferably, the microbial kill is accomplished by heating the condensed, cooked soup in one or more heat exchangers located downstream of the cook-up kettle. The condensed soup preferably is heated to about 175° F. to about 200° F. for about 2 minutes to about 5 minutes, more preferably to about 190° F. to about 200° F. for about 3 minutes to about 4 minutes, and most preferably to a temperature of about 195° F. for about 3 minutes.

Preferably, heating the condensed, cooked soup to achieve sufficient microbial kill includes heating the condensed cooked soup inside a scraped surface heat exchanger. By employing a scraped surface heat exchanger, overcooking and/or burning of the particulate ingredients are significantly reduced or eliminated. Generally, any conventional scraped surface heat exchanger can be used, such as, for example, a scraped surface heat exchanger having a rotating element with spring-loaded scraper blades that scrape the inside surface of the heat exchanger. A preferred scraped surface heat exchanger is manufactured by APV-Crepaco.

In another preferred embodiment, achieving sufficient microbial kill includes heating the condensed, cooked soup inside a first heat exchanger, preferably a scraped surface heat exchanger, to about 190° F. to about 200° F. for about 0.1 to about 1 minute, and then heating the condensed, cooked soup exiting the first heat exchanger in another heat exchanger, preferably a tube-in-tube heat exchanger, to about 190° F. to about 200° F. for about 3 minutes to about 4 minutes.

The preferred method further comprises adding a broth diluent—either before or after the first heat exchanger—to the condensed cooked soup to form a soup product with the desired consistency. It will be readily appreciated by those skilled in the art that the broth diluent may also be added to the condensed, cooked soup just prior to entering the scraped surface heat exchanger or immediately thereafter, or a portion of the broth diluent may be added prior to entering the scraped surface heat exchanger and the remainder at a later stage prior to or simultaneously with the filling step into the retail bags. Preferably, most of the broth diluent is blended in-line with the condensed, cooked soup just prior to dispensing the soup inside the retail bags. In this manner, the exact proportions of condensed soup to diluent are precisely controlled, the solid or particulate ingredients are evenly suspended in the soup and the soup is not overcooked. The soup dispensed in each bag is thus more consistent and has a fresher taste.

As will be apparent from the foregoing description, the preferred method allows large batches of the condensed soup to be cooked at a lower temperature while achieving the necessary microbial kill during a brief exposure of the condensed soup within one or more heat exchanges positioned downstream of the cook-up kettle. The condensed soup is super-heated to the higher temperature only for an amount of time necessary to achieve sufficient microbial kill. Typically, the microbial kill heating lasts only 3-4 minutes just prior to distributing the soup product inside the retail bags. Thus, by virtue of the heat exchangers, the preferred method does not over-process or overcook the soup. In contrast to the present invention, the prior art processes hold residual portions of large batches of soup at high temperatures, often as much as four times the amount of soup filled at the beginning of the batch. The taste, freshness and consistency of soup according to prior processing techniques therefore is compromised.

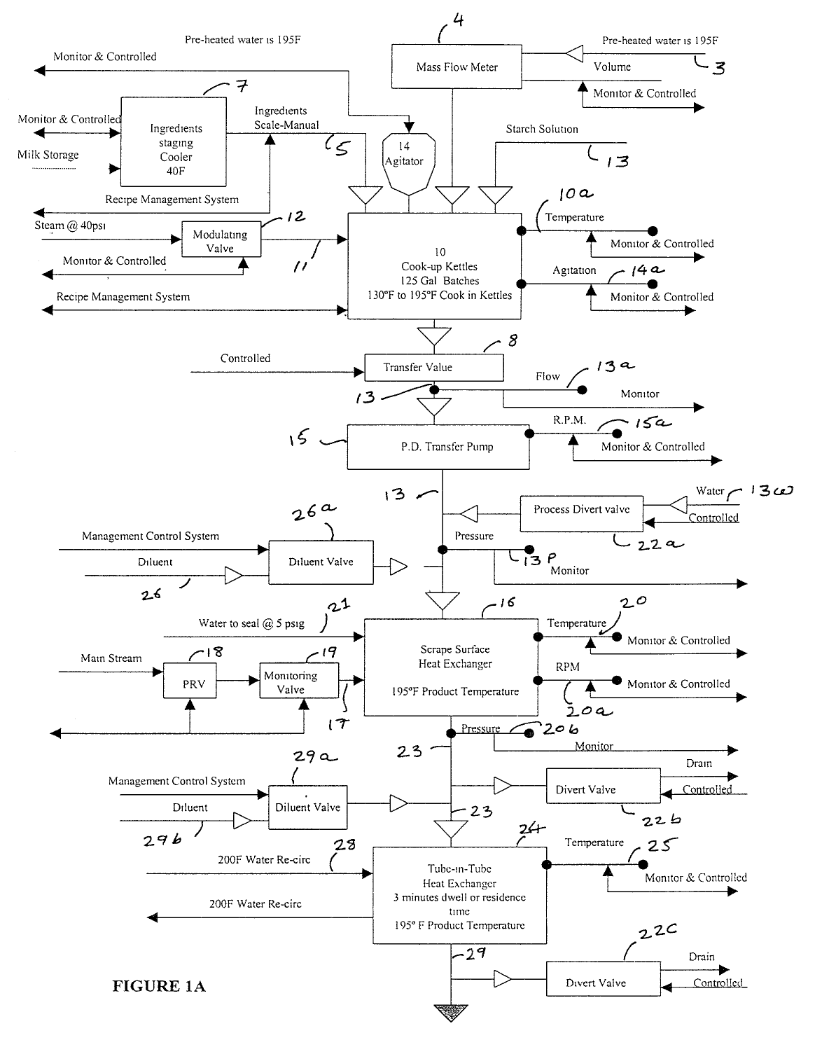

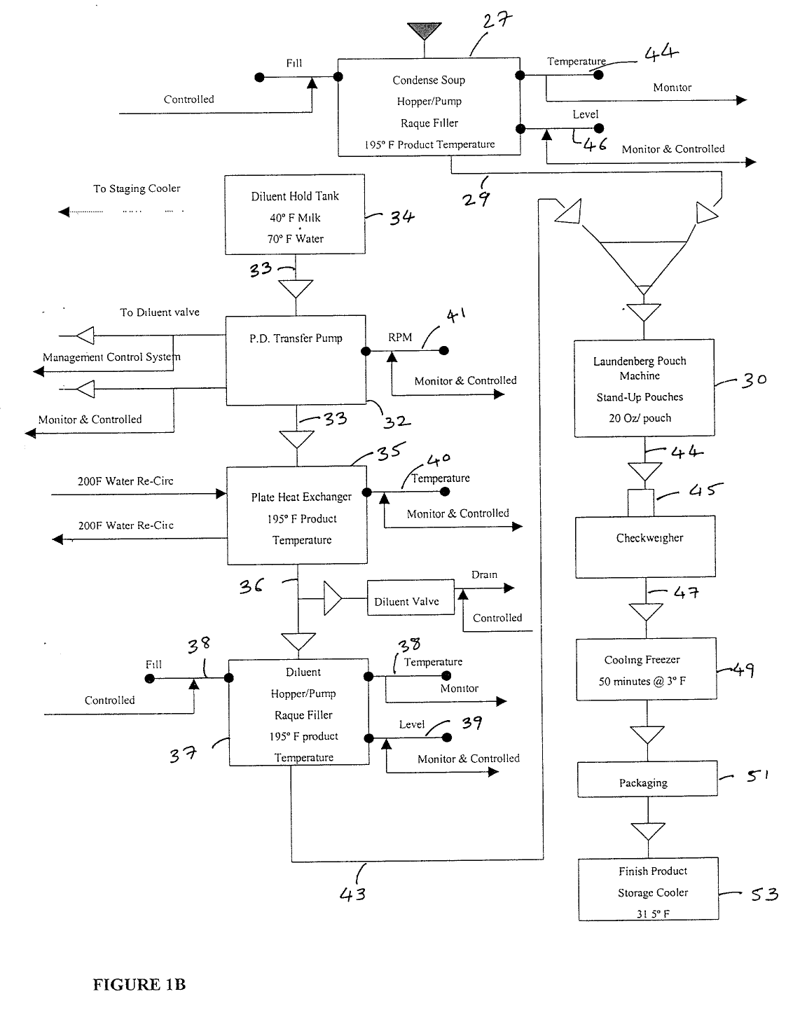

Referring now to FIGS. 1A and 1B, a particularly preferred processing sequence for making the inventive soup is provided. The process includes four conventional control modules referred to as RMS (Recipe Management System), MCS (Management Control System), PCS (Process Control System), and ODS (On Demand System). The soup recipe and process control specifications are stored in the RMS. The RMS is a system for controlling the process for making the soup. The RMS has all of the data stored within itself to include the formulas, the interface between equipment, operators, cooks, software, and hardware. The RMS can down load filler weights and ratios for concentrates and diluents, cooking parameters and ingredient (weigh up) parameters. The RMS also includes the set positive displacement (PD) pump maximum speed, temperatures and process limits for the scrape surface heat exchanger (SSHE), it monitors the On Demand System, and it collects all data about the process.

The ODS is a system that maintains the soup and diluent levels in each hopper on the filler by controlling the PD pump speeds. The ODS also controls the process in the event the pouch machine malfunctions or otherwise ceases to operate, and it takes over for the SSHE, the tube-in-tube heat exchanger, the plate and frame heat exchanger, and the PD pump.

The MCS provides management with the ability to override a process control. The MCS also records all information on the override changes. The Process Control System (PCS) establishes upper and lower limits on the process and maintains the limits on the process by the following: (i) receiving data from all the sensors in the process system; (ii) analyzing the data to determine whether the process is within the established limits (if the data were within established limits, then no corrective action would be needed); or (iii) analyzing the data to determine whether the process is out of the established limits and thus determine what corrective action is needed to bring the process back to the established limits.

Soup ingredients including, for example, starch solution, noodles, vegetables, braised beef meat, and chicken meat, can be measured and added via piping 5 to a cook-up kettle 10 based on criteria generated from the RMS. The soup ingredients preferably are maintained at a temperature of about 40° F. in a staging cooler 7 prior to being introduced into the cook-up kettle 10. Additional starch solution may also be added if needed through piping 13. Water 3, preferably preheated to about 195° F., may also be added in a small amount using a mass flow meter 4.

The cook-up kettle 10 can be of any type or size, and may have a capacity of about 125 gallons. Cook-up kettle 10 preferably is equipped with a steam jacket 11, an agitator 14, and agitation control equipment 14a. Steam is introduced into jacket 11 by means of a modulating valve 12. The temperature of jacket 11 is monitored at 10a and appropriately controlled by controlling the amount of steam permitted to pass through modulating valve 12. The condensed soup inside the cook-up kettle 10 can be cooked according to the parameters specified by the RMS, normally at about 140° F. to about 150° F. for about 10 minutes under moderate agitation. Once the desired cook time is achieved, the RMS notifies that analytical testing on the condensed soup needs to be performed. Analytical testing includes, but is not limited to, analysis for viscosity, salt content, water soluble solids, pH, titratable acidity, water activity, percentage of solids, percentage of salt, and ingredients verification.

If the analytical testing reveals that the soup has not been cooked satisfactorily according to predetermined parameters, the RMS will not allow the condensed cooked soup to leave the kettle 10. After the condensed cooked soup has been cooked according to the specifications prescribed by the RMS, the RMS causes transfer valve 8 to open and starts a positive displacement pump 15. The soup is then transferred from the kettle 10 through transfer valve 8, piping 13 and pump 15, where the soup is delivered to a scrape surface heat exchanger (SSHE) 16. Preferably, pump 15 moves the condensed cooked soup through the entire inventive process.

SSHE 16 heats the condensed, cooked soup to a sufficiently high temperature and for a period of time necessary to achieve a desired microbial kill without burning or otherwise overcooking the particulate ingredients of the condensed soup. The SSHE 16 is typically equipped with a steam jacket 17 operating at from about 3-40 psig steam. Steam is introduced into the steam jacket 17 by means of a pressure regulator valve 18 and modulator valve 19 in accordance with temperature parameters programmed into temperature control equipment 20. RMS controls the volume and pressure of the steam. Water 21, at about 5-psig, can be supplied to the shaft seals (not shown) of the SSHE 16 to prevent the bearings of SSHE 16 from seizing. Additional diluent, e.g., broth, milk or water, may be added to the condensed, cooked soup in line 13 through diluent line 26 and diluent valve 26a.

Pressure monitor 13p monitors the pressure of line 13 for the line pressure of the condensed, cooked soup. If the pressure increases above a pre-set limit, diluent preferably is added to bring the pressure of the condensed, cooked soup to its normal limit.

The condensed, cooked soup then preferably is heated to a temperature of about 195° F. for about 1 minute inside the SSHE 16. The condensed, cooked soup exits the SSHE 16 and is then delivered through piping 23 to a tube-in-tube heat exchanger 24. Optionally, additional diluent may be added through diluent line 29b and diluent valve 29a to the condensed, cooked soup in line 23 before entering the tube-in-tube heat exchanger 24. Once the condensed, cooked soup, with or without the optional additional diluent, enters the tube-in-tube heat exchanger 24 it is maintained at about 195° F. for about 3 minutes. The residence time of the soup within the tube-in-tube heat exchanger 24 is controlled by controlling the speed of pump 15, as well as the volume and length of the tube-in-tube heat exchanger 24. The RMS limits the maximum speed of pump 15 to ensure that condensed cooked soup is held in the tube-in-tube heat exchange for about 3 minutes.

The discharge end of the tube-in-tube heat exchanger 24 is equipped with temperature monitoring equipment 25 and a process divert valve 22c. If the condensed cooked soup is not at the minimum required temperature of 190° F., the RMS will switch the process divert valve 22c to divert the condensed cooked soup, thus preventing it from entering the downstream filler equipment 27 (FIG. 1b). Process divert valves 22a, 22b likewise open for a time sufficient to purge SSHE 16 of condensed soup in the event the PCS senses that pump 15 has stopped for more than a specified amount of time. During this purge, divert valves 22a, 22b switch to allow water 13w to flow through the SSHE 16, thus keeping condensed soup from staying too long and burning, inside the SSHE 16. Water 28 at a temperature of about 200° F. is recirculated through the outer tube of the tube-in-tube heat exchanger 24.

After the tube-in-tube heat exchanger 24, the condensed cooked soup preferably is transferred through filler hopper/pump 27 and line 29 to a filler apparatus 30. The filler hopper/pump 27 is equipped with level control 46 and temperature control 44 equipment. The level control 46 continuously monitors the level in the filler hopper/pump 27 by means of the ODS system. The ODS controls the speed of pump 15 to keep the condensed cooked soup at a substantially constant level in the filler hopper/pump 27. If the level of the condensed cooked soup inside the filler hopper/pump 27 rises above a predetermined level, the ODS will cause the speed of pump 15 to slow down until the desired level in filler hopper/pump 27 is reached. In the event that the maximum level is reached in the filler hopper/pump 27, the RMS will shut down pump 15. The PCS will then reduce the pressure and steam volume supplied to the steam jacket 17 of the SSHE 16 and reduce the temperature of the circulating water 28 in the tube-in-tube heat exchanger 24 to prevent the condensed cooked soup from overcooking.

If the pump 15 has been shut down for a predetermined amount of time, the PCS will cause the process divert valves 22a, 22b to open. This allows water 13w to flow through the SSHE 16 to flush out the condensed soup, thus preventing overcooking of the condensed soup inside the SSHE 16. If, on the other hand, the level in the filler hopper/pump 27 drops below a predetermined value, the PCS will cause the process divert valve 22a, 22b to close and cause the pump 15 to run at a pre-set rate until a pre-set time has elapsed. The ODS will then take over the control of the pump 15 to restore the process parameters to those established by the RMS. However, if the pump 15 has been inactive for a second predetermined time, the PCS will cause the divert valves 22a, 22c to open to allow water to continue to flow through SSHE 16, and also through tube-in-tube heat exchanger 24, to flush out the condensed cooked soup and keep it from sitting in the tube-in-tube heat exchanger 24 and over-cooking. Opening the process divert valve 22c prevents condensed, cooked soup or water from entering the filler hopper 27.

If during normal operation the level in filler hopper/pump 27 drops below a predetermined level, the ODS will cause pump 15 to increase its speed until the desired level is achieved. However, the RMS will limit the speed of pump 15 so that the residence time of the condensed cooked soup in the tube-in-tube heat exchanger 24 does not drop below about 3 minutes. If the level in filler hopper/pump 27 drops below a pre-set level for pre-set period of time and the pump 15 is operating at a maximum limit established by RMS, an alarm is activated to notify personnel that system adjustments are required.

The filler apparatus 30 can be any of many well known devices. Filler apparatus 30 preferably is a Laudenberg filler model no. FBM20PMP manufactured by Laudenberg, and preferably is employed in combination with a Raque Filler no. PF2.5-4 manufactured by Raque Foods. The filler 30 preferably is capable of filling about 80 bags or pouches per minute, each bag containing about 20 ounces of the soup product. Broth diluent, typically water or milk, can be pumped via a positive displacement pump 32 through line 33 from a diluent hold tank and into a heat exchanger 35. The temperature of the diluent preferably is raised to about 195° F. in heat exchanger 35.

Heat exchanger 35 may be a conventional plate-and-frame heat exchanger. Plate-and-frame heat exchangers are generally more economical than heat exchangers designed for sensitive food suspensions such as the scrape-surface heat exchanger employed in the microbial kill procedure of the present invention. The milk or broth inside the diluent hold tank 34 preferably is held at a temperature of about 40° F., while water is held at a temperature of about 70° F. The heated diluent exiting the heat exchanger 35 is transferred through line 36 to a diluent fill hopper 37. The diluent inside the diluent fill hopper 37 preferably is maintained at a temperature of about 195° F. by recirculating water at about 200° F. The diluent from the diluent fill hopper 37 can be transferred through line 43 to the filler 30, where it is measured and blended in-line with the condensed portion of the soup just prior to filling retail bags 45 via line 44.

Filler 30 measures and transfers the specified proportions of condensed soup to diluent broth inside each of the bags 45, thus ensuring that the particulates of the soup are substantially evenly distributed from bag to bag. Each bag then is preferably weighed by a check-weigher to confirm that each bag is filled with substantially the correct amount of specified soup, e.g., 20 ounces ±0.5 ounces.

The bags 45 can be pasteurized by virtue of injecting the hot soup inside the bags 45 at about 195° F. The filled bags 45 then are transferred, preferably by a conveyor belt indicated by line 47, through a cooling freezer 49, where they are held for a sufficient period of time and at a sufficiently low temperature to chill the contents of the bags. Typically, each filled bag 45 is chilled to about 65° F. or less for about 50 minutes inside the cooling freezer 49. Then, the bags are packaged at 51 and stored in storage cooler 53. Preferably, storage cooler 53 is maintained at a temperature of about 31.5° F.

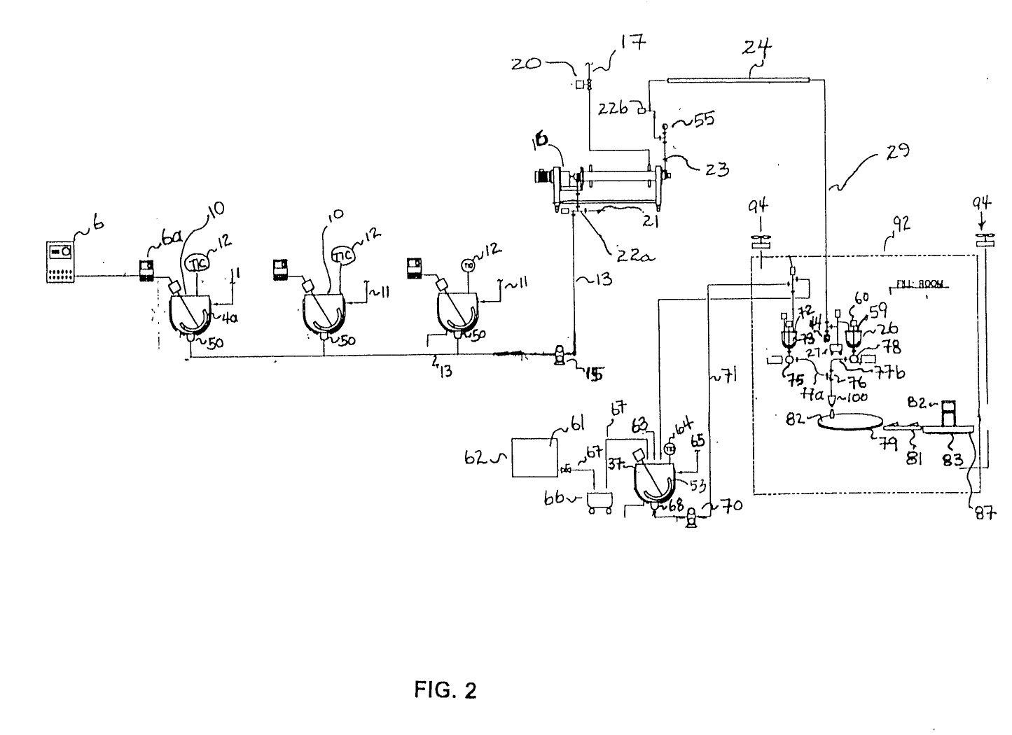

Referring to FIG. 2, a system diagram according to a preferred embodiment is provided. The condensed soup is cooked inside one or more kettles 10. Each kettle 10 is a batch type vessel having a capacity of about 125 gallons and is typically constructed with a steam jacket 11, temperature control equipment 12, and an agitator 4a. Preferably, the agitator 4a is equipped with a concave shaped blade that scrapes the inside surface of the kettle. The operation of each kettle 10 is automated as indicated, for example, by controller 6a and control panel 6. The condensed soup is cooked to a temperature of about 140° F. to about 150° F. for about 10 minutes under moderate agitation.

After cooking, the condensed soup exits kettles 10 through valves 50 and is pumped using a positive displacement pump 15 through pipe 13, e.g., 2.5 inch stainless pipe, to a scrape surface heat exchanger 16. The scrape surface heat exchanger 16 is equipped with a 5-15 psig steam jacket 17. Water 21 is supplied to the shaft seals of the scrape surface heat exchanger to prevent bearing failure due to overheating. Also, process divert valves 22a, 22b are provided upstream and downstream, respectively, of SSHE 16. A temperature element 55 is operatively connected to a steam flow control valve 20 for regulating the flow of steam through the jacket of the SSHE 16 to control the temperature of the condensed soup exiting the SSHE 16 through line 23 to about 195° F. The SSHE 16 is sized to allow a residence time of about 1 minute for the condensed soup at a predetermined flow rate. The condensed, cooked soup exiting the SSHE 16 is delivered through line 23 to a tube-in-tube heat exchanger 24, where it is heated to a temperature of about 195° F. for about 3 minutes. Preferably, the tube-in-tube heat exchanger 24 is insulated. Water at a temperature of about 200° F. can be recirculated through the outer tube of the tube-in-tube heat exchanger 24.

The condensed, cooked soup then exits the tube-in-tube heat exchanger 24 and is transferred via a filler hopper/pump 27 through line 29 to a fill room and to hopper 59. The filler hopper/pump 27 is equipped with a level control (not shown) and a temperature control 44. The condensed, cooked soup is maintained at a temperature of about 195° F. by a recirculating water jacket (not shown) maintained at about 200° F. The condensed soup inside the hopper 59 is agitated using agitator 60 to prevent settling of the soup particulates.

Milk 61 from a milk container 62 is transferred via pump 66 through line 67 into a broth diluent vessel 69. Also, water or broth may be added into the broth diluent vessel 69 through line 63. Vessel 69 is equipped with an agitator 53, a steam jacket 65 and temperature control equipment 64. The broth diluent in vessel 69 may be agitated for better heat transfer and to prevent a skin from forming. The diluent is preferably heated to a temperature of about 195° F. inside vessel 69 under moderate agitation. The heated broth diluent exits vessel 69 through valve 68 and is pumped via a positive displacement pump 70 through line 71 to a surge tank 72. Surge tank 72 is equipped with an agitator 73 that provides sufficient agitation to prevent the milk and water broth diluent from burning a skin coat. Using a Rague Filler, the broth diluent is then delivered at a desired rate to an in-line mixer or mixing valve positioned at the T-shaped junction of lines 77a and 77b. The broth diluent is mixed with the desired amount of condensed soup delivered through line 77b from hopper 59 via a BOCK filler 78.

The soup is then delivered through filling valve 100 to a bag 82. Each bag 82 is positioned on top of a rotating scaler 79 as it is being filled. Preferably, a portion of hot diluent at about 195° F. is injected directly inside the bag 82 to sterilize it prior to filling it with the soup. A conveyor belt 81 carries empty bags to the rotating filler 79 and also transfers the filled bags 82 from the rotating filler 79 to a check-weigher 83. The filled bags 82 are then transferred to a spiral chiller 87.

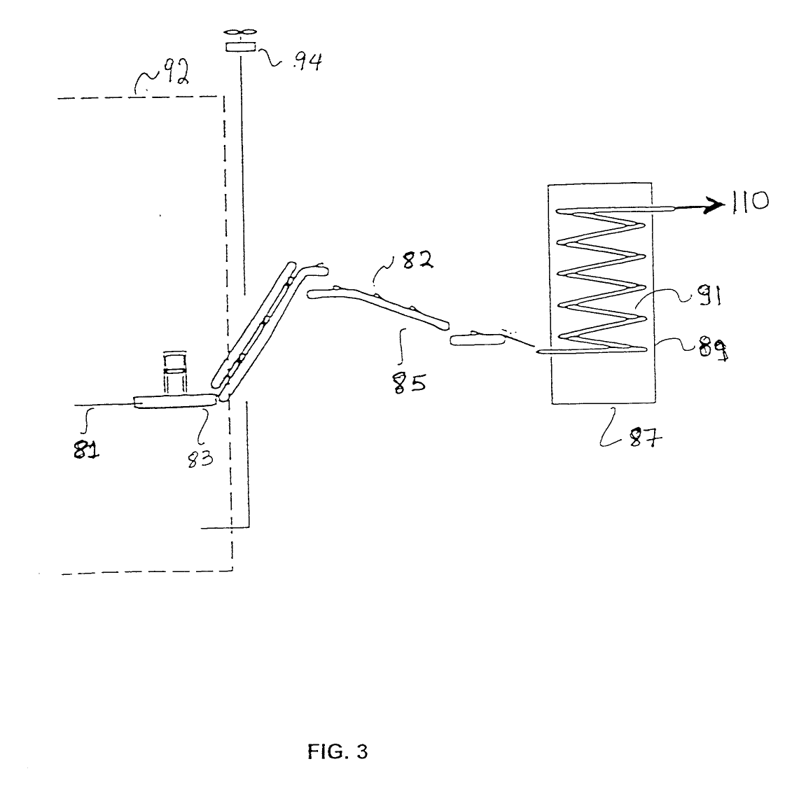

Referring to FIG. 3, a conveyor belt 85 transfers the filled bags 82 from the check-weigher 83 to a spiral chiller 87, where they are chilled to a sufficiently low temperature and for a sufficient time to chill the soup prior to transferring the bags 82 to casing 110 and shipping them to the retail stores. Typically, each filled bag 82 is chilled to about 65° F. or less for about 50 minutes inside the spiral-chiller 87. The spiral chiller 87 comprises a refrigerated chamber 89 and a spiral conveyor 91.

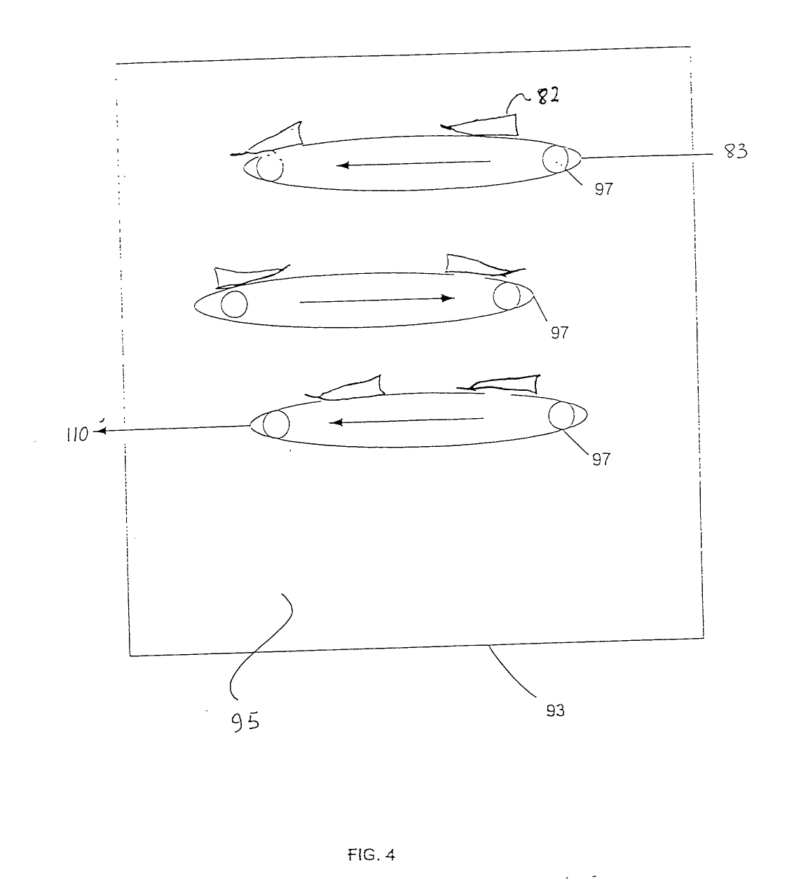

Referring to FIG. 4, another preferred embodiment of a chiller 93 that can be employed to chill the bagged soup is provided. Chiller 93 preferably comprises a refrigerated chamber 95 and a plurality of horizontal conveyors 97 positioned vertically and spaced apart from one another inside the refrigerated chamber 95 in such a manner as to cause the bags 82 to drop and flip as they move from one conveyor to the next. This dropping and flipping action agitates the contents of the bags 82, thus preventing the formation of ice-crystals and allowing both sides of the bag to be chilled homogeneously.

According to another embodiment of the present invention, a second heat exchanger (not shown), preferably a scrape surface heat exchanger, is added downstream of the tube-in-tube heat exchanger 24 (FIGS. 1a and 2) to cool the condensed, cooked soup to about 40° F. prior to storing it inside the bags 82. This embodiment, also referred to as the “cold fill” embodiment, provides a soup with better taste and longer self-life, and is especially preferred with temperature sensitive milk-based soups.

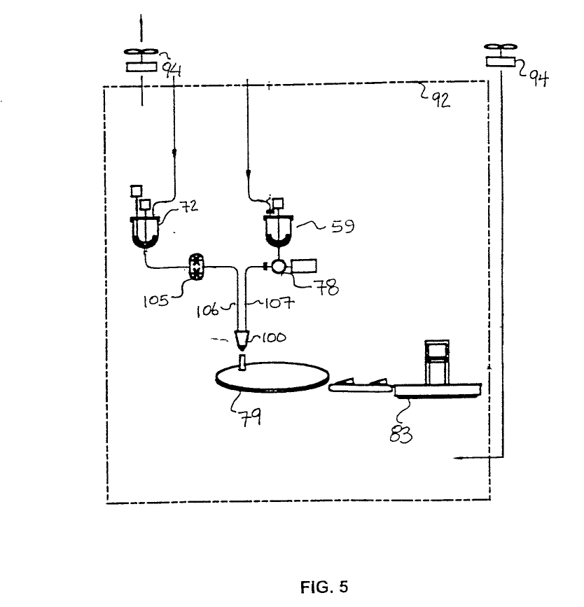

Referring to FIG. 5, another preferred embodiment is provided according to which broth diluent from a diluent surge tank 72 is transferred at a desired amount via a metering pump 105 through line 106 to a filling valve 100. A BOCK filler 78 delivers condensed soup from hopper 59 to the filling valve 100 through line 107. The broth diluent and the condensed soup are mixed inside filling valve 100 just before filling the bags 82. Alternatively, the broth diluent and the condensed soup may be added at the desired amounts directly inside bags 82 without any premixing.

Preferably, the soup is stored inside a stand-up, re-closable, and microwave-able plastic bag that includes front and rear sidewalls and a gusset bottom wall. The front and rear sidewalls each preferably have upper edges and define an open mouth at the upper edges thereof. It is preferred that that the front and rear sidewalls be inwardly tapered from the bottom toward the top of the bag. This is believed to provide more stability to the bag when it is placed in the stand-up position. The gusset bottom wall is disposed between the front and rear sidewalls. It is preferred that the front and rear sidewalls, and the gusset bottom wall be comprised of an interior layer and an exterior layer, the interior layer being heat-sealable within a pre-defined temperature range, and the exterior layer not being heat-sealable within that pre-defined temperature range.

It also is preferred that the gusset bottom wall be comprised of inwardly folded members whereby the lower inside portions of the inwardly folded members are joined to lower inside portions of the front and rear sidewalls at contiguous interior surface portions thereof to form a support band. It is further preferred that the front and rear sidewalls and the inwardly folded members of the gusset bottom wall are joined by heat seals at contiguous portions thereof.

To facilitate joining the front and rear sidewalls and the inwardly folded members of the gusset bottom wall at contiguous portions thereof, it is preferred to provide a cut-out, or punch hole either in the inwardly folded members of the gusset bottom wall, or through the contiguous portions of the front and rear sidewalls and the inwardly folded members of the gusset bottom wall. The cut-out or punch hole will facilitate contact of the interior layers of the contiguous surfaces of the respective wall components, and consequently, a heat seal can be formed when the contiguous portions are heat sealed at the pre-defined temperature range.

In this embodiment of the invention, the interior layer preferably is comprised of a heat-sealable polyolefin film, most preferably a polyethylene film. The exterior layer preferably is comprised of a material that is not heat-sealable within the same temperature range as the heat-sealable polyolefin film useful in the interior layer. Most preferably, the exterior layer is comprised of polyethylene terephthalate. The interior layer is heat-sealable at a pre-defined temperature range that is selected to be the temperature range in which the materials used for the interior layer is heat sealable. Those skilled in the art are capable of selecting suitable materials for the interior and exterior layers, using the guidelines provided herein. In addition, stand-up re-sealable bags comprised of various polymeric and other materials are described in, for example, U.S. Pat. Nos. 5,971,613, 5,860,743, 5,184,986, 4,837,849, and 4,055,109, the disclosures of which are incorporated by reference herein in their entirety. Any of the materials described in these documents are useful in forming the stand-up, re-closable, and microwave-able plastic bag of the present invention.

The bag preferably exhibits an oxygen barrier of less than about 0.025 cc/100 in²/24 hours at 24° C., and at 0% relative humidity (RH), and a moisture barrier of less than about 0.078 g/100 in²/24 hours at 37.8° C., and at 90% RH. The gusset bottom wall preferably has a generally concave or elliptical shape when the bag is filled, and the inwardly folded members of the gusset bottom wall preferably are oppositely inclined at an angle of about 45°. It is further preferred that an adhesive be disposed between the interior and exterior layers of the gusset bottom wall, and that the inwardly folded members of the gusset bottom walls are coextruded films comprised of the interior and exterior layers.

The bag preferably further comprises a re-closable closure device defined on the front and rear sidewalls and adjacent to the open mouth. It also is preferred that the weight ratio of the interior layer to the exterior layer in the gusset bottom wall ranges from about 50 to about 1, preferably from about 10 to about 5. The weight ratio of the interior layer to the exterior layer in the front and rear sidewalls also preferably is within the above-defined ranges.

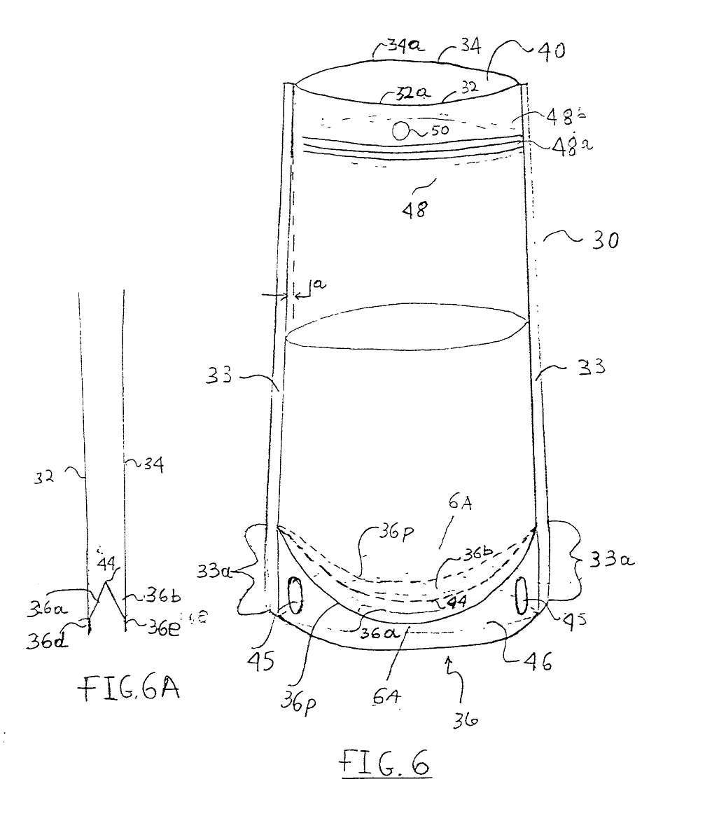

A preferred bag 30 is illustrated in to FIGS. 6 and 6A,. Bag 30 has a pair of front and rear sidewalls 32, 34 and a bottom gusset wall 36. The sidewalls 32, 34 define an open mouth 40 for the bag 30 between the upper edges 32a, 34a of the sidewalls 32, 34. As shown in FIG. 6, the sidewalls 32, 34 preferably are inwardly tapered from the bottom of the bag toward the open mount 40. The gusset wall 36 is positioned between the sidewalls 32, 34. The front and rear sidewalls 32, 34 are joined at both opposite longitudinal edges by heat seal seams 33, which extend throughout the entire vertical height of the bag 30. Prior to forming the side seam seals 33, the bag is provided with a gusset re-entrant fold 44, having a front wall 36a and a rear wall 36b positioned between front and rear side walls 32, 34, which eventually forms the gusset wall 36.

The gusset wall 36 consists of inwardly folded wall members 36a, 36b as shown in FIG. 6A, which is a cross-sectional view along line 6A-6A of FIG. 6. The lower inside portions of the gusset wall members 36a, 36b are joined to lower inside portions of side walls 32, 34 by heat seal seams 36d, 36e, respectively, in a configuration that causes the gusset wall 36 to assume a generally concave shape or elliptical configuration when the bag 30 is filled. Heat seal seams 36d, 36e co-operate with the lower portions 33a of seal seams 33 to form an upright support band 46, which extends below the periphery 36p of the bottom gusset wall 36, when the bag is empty. When completely filled, the periphery 36p of the bottom gusset wall may contact the surface on which the bag is placed, (e.g., the surface of a table).

Heat sealing the longitudinal edges of upright support band 46 (i.e., formed by heat seal seams 36d, 36e) together with the lower portions of 33a of seal seams 33 can be effected in any manner known to those skilled in the art. It is preferred that the longitudinal edges of inwardly folded members 35a, 36b that are disposed within the sealed support band 46 include a cut-out or hole-punch (not shown). Accordingly, when seal seams 33 are formed, the interior layers of the respective sidewalls 32, 34 are in contact with one another at select portions in the lower longitudinal edge portions where the cut-out or punch-hole is formed to effect sealing of lower portion 33a of seal seam 33. Any other technique capable of sealing lower portions 33a can be used in the invention, including those described in, for example, U.S. Pat. No. 4,055,109, the disclosure of which is incorporated herein in its entirety.

It is preferred that the configuration of the periphery 36p of the gusset wall 36 is concave-shaped or elliptical as shown in FIG. 6. In addition, it is preferred that several limited regions 45 within the upright support band 46 remain unsealed to minimize the amount of distortion of the material in the support band 46, which ordinarily results from the heat-sealing process. Regions 45 also provide a cool corner for the user to hold onto when emptying hot contents from the bag.

The sidewalls 32, 34 and the bottom gusset wall 36 of the bag 30 may comprise, for example, two layers of different plastic materials. Preferably, the interior layer is made from a heat sealable polyolefin film, and more preferably polyethylene sealant film that is suitable for direct food contact and microwave applications. The outer layer preferably is comprised of a sturdier material that is not heat sealable within the same temperature range as the first layer. Preferably, the outer layer is made from a polyethylene terephtalate (PET) film. The seals along the longitudinal edges 33 and lower band 46 (33a) are made between the interior polyethylene layer, as described above. An adhesive tie layer may be disposed between the interior and the outer layers to hold the two layers together. Alternatively, the two layers of film can be co-extruded together.

The bag 30 preferably is equipped with a re-closable device 48 near the upper edges 32a, 34a of the bag. The closure device includes of interlocking elements 48a, 48b, which can be integrally formed on the front and the rear sidewalls 32, 34, respectively, or laminated thereon. The bag may also include an opening 50 generally disposed between the closure device 48 and the upper edge of the bag for hanging the bag. The bag 30 is slightly inwardly tapered-from the bottom towards the mouth opening 40. The angle of taper is represented by “a” in FIG. 6. Preferably, the angle of taper is from about 1° to about 25°, and more preferably from about 3° to 10°.

Bag 30 preferably prevents oxygen and moisture transmission, and has sufficient seal strength and burst strength to prevent puncture under normal handling conditions. Preferably, the bag exhibits an oxygen barrier of less than about 0.025 cc/100 in²/24 hours at 24° C., and at 0% relative humidity (RH), and a moisture barrier of less than about 0.078 g/100 in²/24 hours at 37.8° C., and at 90% RH.

Other embodiments and uses of this invention will be apparent to those having ordinary skill in the art upon consideration of the specification and preferred embodiments disclosed herein. The preferred embodiments should be considered as exemplary only and not limiting the scope of the present invention as described in the appended claims.

We claim:

1. A method for making a ready-to-serve soup comprising:
adding soup ingredients inside a vessel to prepare a soup in a condensed form;
cooking the condensed soup to a maximum temperature of about 180° F. and for an effective time to achieve sufficient cooking of the soup ingredients;
heating the condensed, cooked soup to an effective temperature and for an effective period of time to achieve sufficient microbial kill; and
adding a broth diluent to the condensed, cooked soup to form the ready-to-serve soup product having a desired consistency.

2. The method of claim 2, wherein cooking the condensed soup comprises heating the condensed soup to a temperature of from about 140° F. to about 150° F. for about 5 to about 10 minutes.

3. The method of claim 1, wherein the condensed soup is from about 40 to about 85 percent by weight of its final weight.

4. The method of claim 1, wherein achieving sufficient microbial kill comprises heating the condensed, cooked soup to a temperature of from about 190° F. to about 200° F. for about 3 to about 4 minutes.

5. The method of claim 1, wherein achieving sufficient microbial kill comprises heating the condensed cooked soup inside a first heat exchanger at a temperature of about 190° F. to about 200° F. for about 0.1 to about 1 minute, and heating the condensed, cooked soup exiting the first heat exchanger inside a second heat exchanger at a temperature of from about 190° F. to about 200° F. for about 3 to about 4 minutes.

6. The method of claim 5, wherein the first heat exchanger is a scrape surface heat exchanger and the second heat exchanger is a tube-in-tube heat exchanger.

7. The method of claim 1, wherein achieving sufficient microbial kill achieves a 12-log reduction in Listeria Monocytogenes bacteria.

8. The method of claim 1, wherein the broth diluent is selected from the group selected from one or more of milk, water, and mixtures thereof, and the diluent is heated to a temperature of from about 190° F. to about 200° F. prior to being added to the condensed, cooked soup.

9. The method of claim 1, wherein cooking further comprises agitating the soup to prevent clumping of the particulate ingredients.

10. The method of claim 1, wherein the ready-to-serve soup product has a shelf-life of at least 15 days.

11. The method of claim 1, wherein the ready-to-serve soup product has a shelf-life of at least 40 days.

12. The method of claim 1, further comprising filling the ready-to-serve soup product inside a microwaveable, stand-up, re-closable plastic bag.

13. A method for making a ready-to-serve soup comprising:
cooking the soup in a condensed form at a maximum temperature of about 180° F. and for an effective time to achieve sufficient cooking of the condensed soup;
heating the condensed, cooked soup to an effective temperature and for an effective time to achieve sufficient microbial kill;
adding a broth diluent to the soup to form a ready-to-serve soup product having a desired consistency; and
dispensing the ready-to-serve soup inside microwaveable containers.

14. The method of claim 13, wherein cooking comprises heating the condensed soup to a temperature of from about 140° F. to about 150° F. for about 5 to about 10 minutes.

15. The method of claim 13, where the condensed soup is from about 40 to about 85 percent by weight of its final weight.

16. The method of claim 13, wherein the effective temperature is from about 190° F. to about 200° F. and the effective time is from about 3 to about 4 minutes.

17. The method of claim 13, wherein heating the condensed, cooked soup comprises heating the condensed, cooked soup inside a first heat exchanger at a temperature of about 190° F. to about 200° F. for about 0.1 to about 1 minute, and heating the condensed, cooked soup exiting the first heat exchanger inside a second heat exchanger at a temperature of from about 190° F. to about 200° F. for about 3 to about 4 minutes.

18. The method of claim 16, wherein the first heat exchanger is a scrape surface heat exchanger and the second heat exchanger is a tube-in-tube heat exchanger.

19. The method of claim 13, wherein heating achieves a 12-log reduction in Listeria Monocytogenes bacteria.

20. The method of claim 13, wherein the broth diluent is selected from the group consisting of one or more of milk, water, and mixtures thereof, and the diluent is heated to a temperature of from about 190° F. to about 200° F. prior to being added to the soup.

21. A microwavable, stand-up, reclosable plastic bag comprising:
front and rear sidewalls each having upper edges and defining an open mouth at the upper edges thereof; and
a gusset bottom wall disposed between the front and rear sidewalls;
wherein the front and rear sidewalls, and the gusset bottom wall are comprised of an interior layer and an exterior layer, the interior layer being heat-sealable within a pre-defined temperature range, and the exterior layer not being heat-sealable within that pre-defined temperature range;
wherein the gusset bottom wall is comprised of inwardly folded members whereby the lower inside portions of the inwardly folded members are joined to lower inside portions of the front and rear sidewalls at contiguous interior surface portions thereof to form a support band;
and wherein the front and rear sidewalls and the inwardly folded members of the gusset bottom wall are joined by heat seals at contiguous portions thereof.

22. The bag as claimed in claim 21, wherein the interior layer is comprised of a polyethylene film, and the exterior layer is comprised of polyethylene terephthalate.

23. The bag as claimed in claim 21, wherein the bag exhibits an oxygen barrier of less than about 0.025 cc/100 in²/24 hours at 24° C., and at 0% relative humidity (RH), and a moisture barrier of less than about 0.078 g/100 in²/24 hours at 37.8° C., and at 90% RH.

24. The bag as claimed in claim 21, wherein the gusset bottom wall has a generally concave or elliptical shape when the bag is filled.

25. The bag as claimed in claim 21, wherein the inwardly folded members of the gusset bottom wall are oppositely inclined at an angle of about 45°.

26. The bag as claimed in claim 21, wherein an adhesive is disposed between the interior and exterior layers of the gusset bottom wall.

27. The bag as claimed in claim 21, wherein the inwardly folded members of the gusset bottom walls are coextruded films comprised of the interior and exterior layers.

28. The bag as claimed in claim 21, further comprising a re-closable closure device defined on the front and rear sidewalls and adjacent to the open mouth.

29. The bag as claimed in claim 21, wherein the weight ratio of the interior layer to the exterior layer in the gusset bottom wall ranges from about 10 to about 5.
